(19) United States
(12) Patent Application Publication
(10) Pub. No.: US 2005/0080695 A1
(43) Pub. Date: Apr. 14, 2005

(54) System and method for facilitating the selection of security analyst research reports

(76) Inventor: Joseph G. Gatto, San Francisco, CA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/681,286

(22) Filed: Oct. 9, 2003

(51) Int. Cl. G06F 17/60

(52) U.S. Cl. 705/35

(57) ABSTRACT

A system and method for facilitating the selection of security analyst research reports is provided. Investors (or other users) seeking to efficiently target and access only those security analyst research reports most likely to assist in an investment-related decision may access an application. The application may enables users to simultaneously view (e.g., via a graphical user interface) current predictions of security analysts (or other contributors), research report objects associated with the predictions, and data, metrics, or other information corresponding to the historical performance of predictions made by the analysts. By simultaneously displaying historical performance data for contributors, along with their current predictions and research report objects associated with their current predictions, users are provided with objective criteria by which to guide their selection of research reports.

### CROSS-REFERENCE TO RELATED APPLICATION

This application is related to U.S. application Ser. No. 10/119,082, filed Apr. 10, 2002; U.S. application Ser. No. 10/118,237, filed Apr. 9, 2002; U.S. application Ser. No. 09/982,838, filed Oct. 22, 2001; U.S. application Ser. No. 09/893,460, filed Jun. 29, 2001; U.S. application Ser. No. 09/775,599, filed Feb. 5, 2001; U.S. application Ser. No. 09/722,050, filed Nov. 27, 2000; U.S. application Ser. No. 09/577,317, filed May 24, 2000; U.S. application Ser. No. 09/524,253, filed Mar. 13, 2000; U.S. application Ser. No. 09/296,620, filed Apr. 23, 1999 (now U.S. Pat. No. 6,510,419 B1); and U.S. Provisional Application Ser. No. 60/082,868, filed Apr. 24, 1998, each of which are incorporated herein by reference in their entirety.

### FIELD OF THE INVENTION

The invention relates generally to a computer-implemented system and method for helping an investor, analyst, or other user to determine whether to access research (e.g., a report) corresponding to a current prediction (e.g., an earnings estimate, buy/sell recommendation, or other prediction) of a security analyst or other contributor, by providing the user with data, such as the historical performance of predictions made by that security analyst or other contributor.

### BACKGROUND OF THE INVENTION

Many individuals, institutions, and other contributors analyze financial data and other information, at least in part to predict future economic events and issue research reports. The term contributor, as used herein, may include for example, security analyst, broker, or any other individual providing a prediction concerning an equity security. In many instances, for convenience, this specification refers to security analysts. It should be understood that any recitation of security analyst (or “analyst”) may include any contributor.

The role of the security analyst is generally well-known and includes, among other things, issuing earnings estimates for securities; issuing other financial estimates concerning future economic events (e.g., revenue); providing recommendations on whether investors should buy, sell, or hold financial instruments, such as equity securities; and issuing other predictions. As used herein, the term prediction may include, but should not be limited to, one or more of contributor estimates of earnings for a security, buy/sell/hold recommendations, revised estimates, stock price targets, or other predictors. Earnings may encompass, for example, revenue, cash flow, operating income, etc., either on a gross or per share basis. Estimates may include, but are not limited to, quarterly and annual estimates for entities (e.g., companies) whether or not they are traded on a public securities exchange. Fiscal events may include earnings, revenue, cash flow, or other quantities to be reported by an entity for one or more fiscal periods, or other time periods. For simplicity, in many cases, this specification refers to analysts' estimates. It is to be understood that the invention is not so limited.

Analysts generally predict a stock's quarterly or annual earnings well in advance of the time the actual earnings are announced, and from time to time, update their predictions. These predictions may be recorded, for example, in Thomson Financial's First Call or Institutional Brokers Estimates Service (“I/B/E/S”) database, and other commercial databases.

Many investors and other users consult research reports or notes associated with analysts' predictions to explore the rationale and information behind those predictions. As used herein, research reports may include, but should not be limited to, any written or electronic communication that a contributor has distributed or will distribute to customers, to the general public, or to other individuals which presents a prediction or other information concerning an equity security.

Research reports typically include one or more of, for instance, a brief description of an entity (e.g., a corporation) to which a prediction relates, a brief prognosis on the future of the entity, earnings estimates, a buy/sell/hold recommendation, the bases for the estimate or recommendation, or other information. Regulations promulgated by the National Association of Securities Dealers, Inc. (“NASD®”) may further define the content of research reports, particularly when research reports are provided by contributors affiliated with NASD® members.

When used effectively, research reports have the potential to add value to the decision-making process of investors. However, there can be large numbers of research reports on individual securities, industries, etc. Currently, it is difficult for users to read all such research reports given the amount of time available. The problem is that reading all research reports may waste time and not necessarily add proportionate value. On the other hand, arbitrarily deciding to not read a particular research report may cause vital information uniquely contained in that report to be missed, adversely impacting a decision.

For those users with access to a large volume of research reports from multiple contributors (e.g., via subscriptions to financial information services providers (“FISPs”) which gather and report contributors' predictions and research reports), this method of “unfocused” research may result in a significant expenditure of valuable time. An additional financial drain may be experienced by users that do not have subscriptions to FISPs, and must pay to access research reports.

In addition, there are approximately 6,000 contributors (analysts) from approximately 500 firms that publish to I/B/E/S. It is quite difficult, if not impossible, to understand or discern the quality of the authors of the research reports.

Moreover, biases may exist between contributors and the entities that they are “researching.” Currently, when accessing research reports, users have little information, if any, regarding existing affiliations or relationships between a contributor (or the contributor's employer) and an entity about which the contributor is making predictions. As such, users have little way of knowing when a relationship may bias or unduly influence a contributor's prediction and/or the content of the corresponding research report.

These and other drawbacks exist with current means of accessing research reports.

### SUMMARY OF THE INVENTION

The invention solving these and other problems relates to a system and method for facilitating the selection of research reports.

According to one embodiment, the system of the invention may include a computer-implemented application that is designed to help users efficiently target and access only those research reports most likely to add value when making investment-related or other decisions, by enabling users to base (or filter) their selection of research reports on the past performance of contributors. The application may comprise any computer-implemented system including, for instance, an Internet web site, an intranet site, or other host site or application maintained by a service provider or other entity. The application may be accessed by one or more investors, analysts, or other users interested in researching current contributors' predictions and/or the rationale underlying those predictions.

According to an embodiment of the invention, the invention uses a modular design, including one or more of the following modules: Contributors, Data, History, Performance, Data Source Interface, and Ticker Digest. One or more modules may be combined. For some purposes, not all modules may be necessary. Other modules may be used, including any one or more of the modules (e.g., stocks module and models module) disclosed in those U.S. patent applications incorporated herein by reference.

According to one embodiment, the Data Source Interface module enables the application to access, receive, store, or otherwise manage data from one or more financial data sources, or from one or more databases operatively connected to the application. The data may include data relating to current analysts' predictions and when such predictions were made, research reports, historical data relating to predictions, past earnings reports, or other information. The financial data sources may include, for example, individual security analysts, institutions (e.g., brokerages), public or private databases, Internet or intranet sites maintained by FISPs, other data sources; or any combinations thereof. As an illustrative example, the Data Source Interface module may access data via an application program interface (API) or file transfer protocol (FTP) site provided by a financial data source.

Under the Contributors module, a user may select an analyst, broker, or other contributor; a security; or other category, and view information within these categories, relationships there between, and other information.

According to an embodiment, the Data module enables users to simultaneously view (e.g., via a graphical user interface) current contributors' predictions, timeliness of both individual current predictions and clusters of current predictions, timeliness of revisions to individual predictions and to clusters of predictions, research report objects associated with the predictions, and data, metrics, or other information corresponding to the historical performance of predictions made by the contributors.

The research report objects may comprise icons, graphics, or any other identifiers or indicators (e.g., a link) for notifying a user that a research report is available relating to a given prediction. The research report objects may further comprise access mechanisms for enabling users to access research reports. The term “access” is used broadly herein to include select, preview, display, purchase, download, open, save, print, or to take any other action to otherwise access a research report. As an illustrative example, a research report object may comprise an link that, when selected by a user, accesses and displays (in a computer display) the research report. As one example, this may be done via an API provided by a financial data source (e.g., Thomson Financial, IBES, etc.). As recited above, the Data Source Interface module facilitates this and other data transfers.

Under the History module, historical prediction data (e.g., historical estimates) and actual data (e.g., reported earnings estimates) may be viewed in chart, grid, or other format. For example, a chart view may display estimates and actual data graphically. A snapshot view may display detailed data in tabular format for a selected “As Of Date.” Other historical data and formats may also be used. Under the Performance module, a user may create and display metrics for analyzing analyst performance, analyst and/or broker accuracy reports, aggregated by analyst, broker, ticker, any combination thereof, or in other aggregations. Examples of historical analyst performance data may include relative accuracy scores, relative accuracy ratings, or other metrics which represent the accuracy of analysts' previous estimates. In each of the above identified modules, other options may be available to the user.

According to one aspect of the invention, by simultaneously displaying historical performance data for contributors along with their current predictions and an indication of availability of research report objects associated with their current predictions, users are provided with objective criteria by which to guide their selection of access to research reports. As a hypothetical example, a plurality of analysts may have earnings estimates near a mean (or consensus) value of $1.03 for a selected earnings event for a given security. One analyst (an outlier) may have an estimate of $1.20. If historical performance data reflects that this analyst is not historically accurate, an investor or other user may choose to avoid devoting the time and/or money (collectively referred to herein as resources) necessary to access and read the research report corresponding to the $1.20 estimate. By contrast, if historical performance data for the analyst indicates that the analyst is historically accurate, an investor may be more inclined to access the research report to explore the rationale underlying the $1.20 estimate.

According to one embodiment of the invention, users may select one or more criteria or factors for filtering a selection of current estimates (or other predictions) or research report objects associated with the current estimates. Current estimates may be filtered, for example, by analyst, by broker, by security, by industry, by estimate age, by historical performance data, or by other factors.

According to one aspect of the invention, the performance module (or other aspect of the invention), may associate a score, ranking, rating, or other criteria to various contributors. A user may wish to filter a selection of current estimates and corresponding research report objects by targeting for display or access only those current estimates provided by contributors satisfying certain criteria. For example, contributors (e.g., security analysts) may be grouped into categories corresponding to one to five stars. A user may decide to access only those research reports of contributors having a 5-star performance rating. Alternatively, a user may wish to view all current contributors' estimates for a selected earnings event, and have the current estimates and corresponding research report objects displayed in a descending order (e.g., display predictions and research report objects for 5-star contributors first, followed by 4-star contributors, 3-star contributors, etc.).

According to various implementations, a user may be presented with a display of only the current estimates and corresponding research report objects identified during a filtering operation. In other words, the factors upon which the filtering was based (e.g., historical performance data) may not be displayed. In other embodiments, however, filtering factors may be displayed along with the current estimates and corresponding research report objects. As an example, for any given contributor, a user may view the contributor name, the current estimate, performance data for the contributor (e.g., 1-5 stars), and a selectable icon for accessing the research report authored by the contributors. Other factors including the date of the estimates (or predictions), estimate age, or cluster indications, for instance, may also be displayed.

According to an embodiment of the invention, when filtering by contributor, the application may enable users to scroll through (or otherwise view) in a single display screen, for a single contributor, a list of some or all of the securities, industries, etc. that the contributor covers. For each security listed, a user may view the contributor's current predictions (e.g., earnings per share (EPS) values ) and/or recommendations (e.g., buy, sell, hold) for the security, research report objects corresponding to the current predictions, and an indication of whether the prediction deviates from a user-specified amount from a composite prediction (e.g., the average of all/some contributors with comparable predictions on the same security). Other information may be displayed. A user may further sort the list by comparable item such as, for instance, a stock specific performance, stock rating, or predicted price appreciation (i.e., the difference between target price and current price). In addition, a user may sort the list by predicted surprise, which can be the difference between the contributor's estimate and a composite prediction. Other criteria for sorting the list may be provided.

According to an embodiment of the invention, when filtering by security, the application may enable users to view (in a single display screen) a list of some or all of the contributors having current predictions for a selected earnings event for a given security. The predictions may comprise earnings estimates, recommendations, or other predictions. An earnings event may be defined as including one or more of earnings, revenues, or other financial reports for a security for a given time frame (e.g., quarter, year, etc.). For each contributor listed for a given security, a current prediction may be displayed along with a research report object corresponding to the prediction if a research report is available. One or more indications of the contributor's historical performance with regard to that security, or for a similar security for the same type of event, may also be displayed.

According to an embodiment of the invention, a user may wish to view an unfiltered selection of current estimates and corresponding research report objects. In such an instance, where there has been no action taken by a user to separate historically accurate contributors from historically inaccurate contributors, indicators of historical performance (e.g., RAS values, star ratings, or other rankings or measures) may be displayed for each contributor for which a current prediction is listed. The historical performance data may be a measure of the contributor's performance related to that security for which the current prediction is listed, for any selection of securities, or for all securities for which that contributor has made previous predictions. This simultaneous display of historical performance data together with current contributors' estimates and corresponding research report objects may provide users with immediate objective criteria by which to guide their selection of research reports.

According to an embodiment of the invention, users may wish to obtain additional information about a contributor, the contributor's current prediction, the corresponding research report, or historical performance data for the contributor to assist in the determination of whether to access the research report. As such, a user-selectable “information” link, button, tab, or other object may be provided for each prediction displayed.

A user may select the “information” object to obtain additional information about, for example, the contributor, an entity with which the contributor is affiliated, the cost (if any) to access the research report, the number of pages of the research report, and the file size (bytes) of the research report for downloading. A user may also wish to preview an abstract or snapshot of the research report prior to accessing to the research report. Additional information may be provided. Information pertaining to existing affiliations or relationships between a contributor (or the contributor's employer) and an entity (e.g., a company about which the contributor is making predictions) may be of particular value, especially in those instances where a relationship may bias or unduly influence a contributor's prediction and/or the content of the corresponding research report. As an example, an investor or other user may want to know whether a contributor's favorable prediction for a security was due, in part, to the fact that the contributor was being paid by an entity (e.g., company) to cover its' security, or if some other relationship existed.

According to another embodiment, a separate information object (e.g., icon) or access mechanism may not be provided. Rather, a user may obtain additional information by selecting the actual research report icon (or object) itself. This information may be displayed along with prompts to either proceed to access (e.g., purchase) the research report, or to cancel and return to a previous view. Other implementations may exist.

For any of the foregoing embodiments, or for any other embodiments in which historical performance data may be displayed simultaneously with a current prediction (e.g., alongside or otherwise), a symbol or other graphical representation may be used to indicate when a “distinguished” or historically accurate analyst has a “non-consensus” prediction. For ease of explanation, such “bold” predictions may be referred to herein as “bold estimates.” It should be understood, however, that “bold recommendations” may also be used where appropriate.

According to an embodiment of the invention, a bold estimate may be an estimate that deviates by predetermined criteria from the consensus (or other measure) on a stock, stock sets, and/or other earnings events. For example, recent bold estimates made by one or more top performing analysts (e.g., five star analysts) may be highlighted in bold, or otherwise visually distinguished.

As described in detail herein, relative accuracy scores measure the accuracy of each analyst's forecasts as compared against fellow analysts for the same security. For an analyst to receive a high score, the analyst may make estimates that are both significantly different from and more accurate than other analysts' estimates. Top-performing analysts (e.g., those that receive five stars) may have deviated from the consensus in the past and have been significantly more accurate than the other analysts. Generally, high-scoring analysts in the past are likely to continue to be high-scoring analysts. Thus, when a five star (or top performing) analyst makes a bold call, this often signals a major opportunity on the stock (or earnings event). In short, the identification of bold estimates by five star (or top performing) analysts may be a valuable guide to investors or other users when determining which research reports to consult.

According to an embodiment of the invention, investors or other users may access (or subscribe) to a Ticker Digest to customize monitoring criteria and other parameters for securities of interest. Through various features and functions enabled by the Ticker Digest Module, a user may specify which selection of securities should be monitored, and for what interval of time. For each security selected, a user may define criteria of interest, and further specify how and when they wish to be notified should the user-defined criteria be satisfied. One of the advantages of the Ticker Digest is the ability to identify relevant activity for some or all contributors (e.g., based on user-selected criteria), on user-selected stocks. This functionality may serve to greatly facilitate the research process by enabling users to begin their research with what is perhaps the most relevant information, and by avoiding unnecessary expenditure of resources.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention. For example, according to various embodiments of the invention, historical data, current predictions, and research report objects corresponding to current predictions may be arranged, filtered, analyzed, and displayed in any number of configurations including, for example, by analyst, broker, security, industry, historical performance or accuracy, or other category. Such configurations may be similar to those disclosed and illustrated in those U.S. patent applications incorporated herein by reference.

### BRIEF DESCRIPTION OF THE DRAWINGS

FIG. 1 is a schematic diagram of a system for facilitating the selection of one or more research reports, according to an embodiment of the invention.

FIG. 2 illustrates an exemplary view of data that has been filtered by contributor, according to an embodiment of the invention.

FIG. 3 illustrates an exemplary view of data that has been filtered by contributor, according to an embodiment of the invention.

FIG. 4 illustrates an example of a ticker digest module, according to an embodiment of the invention.

FIG. 5 illustrates an example of a ticker digest highlights view, according to an embodiment of the invention.

FIGS. 6A-6B illustrate examples of commingled data views, according to an embodiment of the invention.

FIG. 7 illustrates an example of a research report display view, according to an embodiment of the invention.

FIG. 8 illustrates a flowchart of processing according to the invention, in one regard.

### DETAILED DESCRIPTION OF THE PREFERRED EMBODIMENTS

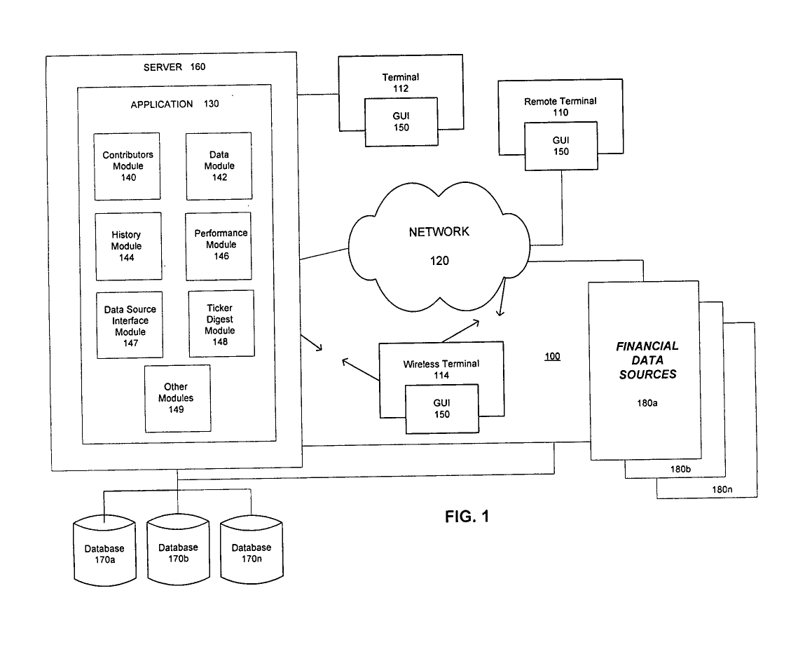

According to an embodiment of the invention illustrated in FIG. 1, a system 100 is provided for helping investors (or other users) efficiently and intelligently select research reports. System 100 may include a server 160 which may be or include, for instance, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep™, or other operating system or platform.

According to an embodiment of the invention, server 160 may host an application 130. Application 130 may comprise an Internet web site, an intranet site, or other host site or application maintained by a service provider, or other entity. Application 130 may be accessed by investors, analysts, or any other users for managing and viewing historical data including analysts' predictions and actual reported data; for measuring, analyzing, and tracking the historical performance of security analysts' predictions; and for effectively using data corresponding to the historical performance of predictions of an analyst to determine whether to access a research report corresponding to a current prediction made by that analyst. Application 130 may also be accessed to utilize any of the various features and functions as set forth in those U.S. patent applications incorporated herein by reference.

According to an embodiment of the invention, application 130 may comprise a contributors module 140, data module 142, history module 144, performance module 146, data source interface module 147, ticker digest module 148, and other modules 149, each of which may implement the various features and functions (as described herein) that aid in facilitating the selection of one or more analyst research reports. One or more of the modules comprising application 130 may be combined. For some purposes, not all modules may be necessary.

In operation, one or more users may access server 160 and application 130 through an interface. By way of example, server 160 may comprise a web server and the interface may comprise a web browser. Those having skill in the art will recognize that other client/server and network configurations may be used.

According to an embodiment, the interface may comprise a graphical user interface (GUI) 150. The GUI 150 may be displayed via a terminal 112, such as a personal computer, workstation, dumb terminal, or other user terminal networked to the server 160. A user may also access server 160 through GUI 150 displayed on a remote terminal 110. Remote terminal 110 may be connected to server 160 over a network 120, via a communications link.

Network 120 may include any one or more of, for instance, the Internet, an intranet, a PAN (Personal Area Network), a LAN (Local Area Network), a WAN (Wide Area Network), a SAN (Storage Area Network), or a MAN (Metropolitan Area Network). Any suitable communications link may be utilized, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, or other connection.

In addition, users may also access server 160 through GUI 150 displayed on a wireless terminal 114, such as a portable computer, personal digital assistant (PDA), wireless phone, web-enabled mobile phone, WAP device, web-to-voice device, or other wireless device.

According to an embodiment of the invention, one or more databases (170a, 170b . . . 170n) may be operatively connected to server 160. Databases (170a, 170b . . . 170n) may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Language Query), a SAN (storage area network), Microsoft Access™ or others may also be used, incorporated, or accessed into the invention. Databases (170a, 170b . . . 170n) may store data provided by one or more financial data sources (180a, 180b . . . 180n).

According to various embodiments of the invention, financial data sources (180a, 180b . . . 180n) may be directly networked to server 160, or operatively connected to server 160 through network 120. In addition, financial data sources (180a, 180b . . . 180n) may also be directly connected to databases (170a, 170b . . . 170n). According to one embodiment, financial data sources (180a, 180b . . . 180n) may include sources of analysts' predictions, research reports, or other data, and may comprise, for example, individual security analysts, institutions (e.g., brokerages), combinations thereof, or other sources. Financial data sources (180a, 180b . . . 180n) may further comprise one or more databases (e.g., Institutional Brokers Estimates Service (“IBES”) database), an Internet web site, an intranet site, or other host site or application, or any combination thereof, maintained by a financial information services provider (e.g., Thomson Financial), or other entity.

According to an embodiment of the invention, data source interface module 147 may enable application 130 to access, receive, store, or otherwise manage data from financial data sources (180a, 180b . . . 180n), or from databases (170a, 170b . . . 170n). As an illustrative example, data source interface module 147 may access data via an application program interface (API) or file transfer protocol (FTP) site provided by a particular financial data source (e.g., 180a).

Those having skill in the art will appreciate that the invention described herein may work with various system configurations, including those set forth in the U.S. patent applications incorporated herein by reference. Accordingly, more or less of the aforementioned system components may be used and/or combined in various embodiments.

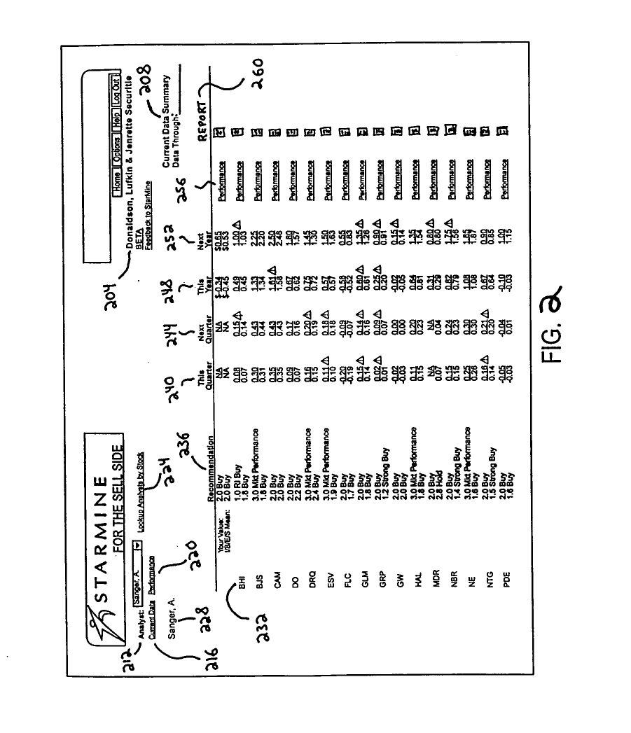

The various features and functions enabled by the modules of application 130 will now be discussed with reference to the various views illustrated in FIGS. 2-7. It should be understood that the views described in detail below, and illustrated in the accompanying drawing figures, are exemplary and may differ in appearance, content, and configuration. Further, and as may be described herein, the terms “button,” “pull-down or drop-down menu,” “tab,” “click-box,” “check-box,” “hypertext link,” and “hot link,” are each particular examples of a generic “selection portion” which may comprise any known navigational tool that enables users to select, access, display, or navigate through the various views, portions, or modules of application 130. The selection portions may be accessed using any known input device associated with terminals 110, 112, 114) such as, for example, a keyboard, computer mouse, light stylus instrument, or finger or other body part in a touch-screen implementation.

While a selection portion may be described and illustrated as a button in one embodiment, it could comprise a different selection portion (e.g., a check-box) in an alternative embodiment. These selection portions may be present in addition to the various navigational tools that may be unique to, or associated with, a web browser (e.g., Netscape™) or other GUI 150 used to access application 130.

According to one embodiment of the invention, users may select one or more criteria or factors for filtering a selection of current estimates (or other predictions) and research report objects associated with the current estimates. Current estimates may be filtered, for example, by contributor (e.g., analyst, broker, etc.), by security, by industry, by estimate age, or by historical analyst performance data. Other filtering criteria or factors may be used.

FIG. 2 is an example of a view that may be presented to a user that has decided to filter by analyst. As shown, a user may select an analyst name by scrolling through a list via a drop-down menu 212. Other methods of selecting may also be used. Once an analyst has been selected, his or her name may be displayed at section 228. A firm or entity name with which the analyst is affiliated (if any) may be displayed at section 204. A data summary section 208 may provide a brief description of the presented data to inform a user of the current age of the data displayed. In general, data regarding analysts, brokers, securities, and relationships there between, may be managed by contributors module 140 (FIG. 1).

Once an analyst has been selected, various viewing options are available. For example, a user may view current data by selecting link 216, or view performance data by selecting link 220. Performance data may include all analysts associated with a firm including analyst name, core, relative accuracy (in terms of star ratings), number of stocks followed by the analyst, and other information. This information may be managed by performance module 146 (FIG. 1). Other data views may be available. For example, a user may lookup analysts by stock by selecting link 224. Other firm-wide data views may also be accessible by users.

According to an embodiment of the invention, a current data view for a selected analyst may display the stocks covered by the analyst, the analyst's current recommendations, and the analyst's EPS estimates. The analyst's estimates may be further broken down by time period, such as quarter and year. A user may select Current Data at 216 to view data associated with an identified analyst. Current data may include the analyst estimates as compared to the IBES mean for stocks followed by the analyst. The analyst estimates may also be compared to other measures of estimates.

In this example shown in FIG. 2, analyst “Sanger, A” has been selected. Under column 232, a list of stock tickers followed by the selected analyst may be displayed. Under column 236, a set of recommendations may be presented for each stock. Each set of recommendations may include the analyst's value and the IBES mean. The analyst's values may be compared to other measures. In some circumstances, different firms may implement different recommendations and values. To establish standardization, these recommendations may be converted to a standard scale, to indicate positive and negative recommendations. For example, a scale of 0 to 5 may be used. In this example, a lower number may indicate a more positive recommendation while a higher number may indicate a negative recommendation.

For example, for the stock ticker “BHI,” the analyst has assigned a recommendation of “1.0 RI Buy,” and the IBES mean has assigned a recommendation of “1.8 Buy.” Other possibilities may include Strong Buy, Market Performance, Sell, Hold, and other recommendations. Under column 240, the analyst estimate and the IBES mean may be presented for this quarter. Also, in column 244, the analyst estimate and the IBES mean may be presented for the next quarter. Under column 248, the analyst estimate and the IBES mean may be presented for this year. Also, the analyst estimate and the IBES mean may be presented for the next year, in column 252. Other periods of time may also be used. This and other current data may be managed and displayed by data module 142 (FIG. 1).

Column 256 allows the user to view an analyst's performance data for each security. Performance data may be generated, managed, or displayed by either or both of history module 144 and performance module 146, each of which are illustrated in FIG. 1.

Additionally, as illustrated in FIG. 2, a column 260 of research report objects may be displayed simultaneously with the current predictions to which they correspond, and with performance data for the analyst. As recited above, the research report objects may comprise icons, graphics, or any other identifiers or indicators (e.g., links) for notifying a user that a research report is available for a given prediction. The research report objects may further comprise access mechanisms for enabling users to select, preview, display, purchase, download, open, save, or print research reports. By simultaneously displaying or providing historical performance data for analysts (in column 256), along with their current predictions (columns 236, 240, 244, 248 and 252), and research report objects (column 260) associated with their current predictions, users are provided with objective criteria by which to guide their selection of research reports.

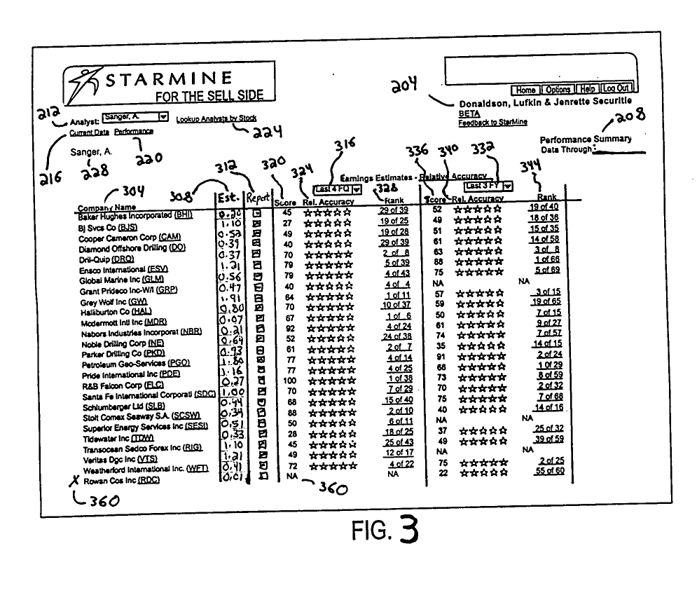

FIG. 3 is an additional example of a view in which an analyst's current predictions are simultaneously displayed with corresponding research report objects, and with historical performance data. Performance data may include relative accuracy scores and star ratings, each of which are described in detail in U.S. patent application Ser. No. 09/775,599, which is incorporated herein by reference in its entirety. In column 304, a company or entity name is listed along with its associated stock ticker. The analyst's current earnings estimate for each entity listed is provided in column 308. In column 312, research report objects corresponding to each estimate are provided.

A Relative Accuracy Score (“RAS”) measures earnings estimates accuracy over a selected time period where analysts are compared against other analysts. RAS calculations take into account the absolute accuracy of an individual analyst, the accuracy relative to other analysts, the variance among the analysts, and the time horizon until the actual earnings announcement. Rather than taking the simple average of performance across all time periods, the application may implement an algorithm that accounts for the length of time a stock was covered during a predetermined period (e.g., quarter or year), the number of securities covered, as well as other factors and considerations for obtaining comprehensive and representative relative accuracy scores.

Relative accuracy ratings are a visual method of representing relative analyst performance. For example, different ranges of RAS values may be assigned corresponding symbols (e.g., stars) or other indicators of relative accuracy. According to one example, a greater number of stars (e.g., five stars) may signify high accuracy, while a lower number of stars e.g., 1 star) may signify low accuracy. Thus, symbols or other identifiers may be assigned to a score that falls within a defined range to indicate varying degrees of accuracy and overall performance. The algorithms for calculating RAS values and for generating corresponding star ratings are set forth in detail in U.S. patent application Ser. No. 09/775,599, which is incorporated herein by reference in its entirety.

According to one embodiment, relative accuracy score (RAS) information may be displayed for a selected time period using drop-down menu 316. In the example illustrated, the selected period is the last 4 fiscal quarters. Other time periods may include the last fiscal quarter, last 8 fiscal quarters, last fiscal year, last 2 fiscal years, last 3 fiscal years, etc. Other time periods may also be identified. Relative accuracy scores for securities followed by the selected analyst may be listed in column 320 for the selected time period. A relative accuracy star rating may be displayed in column 324. In addition, the selected analyst's ranking for each stock may be displayed in column 328. The analyst's rank, and the total number of analysts following the stock are each shown. In this example, analyst Sanger is ranked 29^{th} out of 39 analysts for the “BHI” stock.

Another time period may also be simultaneously selected for comparison and analysis. In this example, the last three fiscal years have been selected using drop-down menu 332. Column 336 displays the relative accuracy scores for this second time period. Relative accuracy star ratings may be displayed for the selected analyst, for the second time period, in column 340. In addition, a symbol may be used to indicate that there are no currently active estimates or recommendations. This symbol may comprise an “x” or other identifier, as shown by symbol 360. As illustrated, some analysts from firms may be listed as “N/A”. When viewing the performance of analysts by stock, the analysts who are ranked below the mean may be anonymous to outside firms. In other words, according to an embodiment of the invention, a user may view the performance of all the analysts in the user's firm, but may be restricted in viewing only analysts with better than average performances in other firms.

According to an embodiment of the invention, relative performance data for a stock may be displayed by selecting on a ranking score. For example, a user may desire to view more detailed performance information in relation to an analyst's score of 100, with an associated 5-star ranking. In the example shown, selected analyst, “Sanger, A,” has a ranking of 1 out of 38 for R&B Falcon Corp (FLC). By selecting this analyst's ranking in column 328, the user may view a rank of all analysts following the associated ticker.

Analyst estimates for a stock may be ranked in relation to other analysts who follow the same stock. The ranking of relative accuracy may be based on relative accuracy scores calculated for each analyst for each stock that is followed. This feature provides a useful measure of accuracy and assessment of relative performance for various stock events. While a star rating may provide a clear measure of relative accuracy, the analyst rank for a stock may provide a more detailed indication of an analyst's standing and performance with respect to other analysts. Also, a relative accuracy score may be given more depth and insight when presented with the analyst's actual rank out of a total number of analysts who follow the stock.

The RAS values, star ratings, and rankings illustrated in FIG. 3 are all examples of information that can help investors (or other users) efficiently target and access those research reports most likely to assist in an investment-related decision.

It should be understood that FIGS. 2-3 are examples of views that may be presented to a user when filtering by analyst, and should not be viewed as limiting. In alternative embodiments (not illustrated), users may also be provided with indicators for displaying whether an analyst's prediction deviates from a specified amount from the average of all/some analysts with comparable predictions on the same security. Other information may also be displayed. A user may further sort analyst data by comparable items such as, for instance, a stock specific performance, stock rating, or predicted price appreciation (i.e., the difference between target price and current price). For example, although not illustrated, a user may select to display a listing of securities covered by an analyst, based on the analyst's star ratings in a descending order (e.g., show securities for which the analyst has a 5-star rating, followed by 4-star ratings, 3-star ratings, etc.). In addition, a user may sort analyst data by predicted surprise, which is the difference between the analyst's estimate and the average of all or some analysts' estimates of the same quantity. Other criteria for sorting analyst data may be provided.

In addition to filtering a selection of current estimates by analyst, users may also filter by broker, by security, by industry, by historical performance data, or by other factors.

According to an embodiment of the invention, users may wish to obtain additional information about the data displayed in the views of FIGS. 2-3 (or in the views of any other FIGS.), to assist in the determination of whether to access a research report. For example, a user may wish to obtain additional information about a selected analyst, the analyst's current prediction, historical performance data for the analyst, or any relationships or affiliations that the analyst may have with any entities. Information pertaining to existing relationships or affiliations between an analyst and an entity may be of particular value, especially in those instances where an analyst's prediction and/or the content of the corresponding research report may be unduly influenced or otherwise biased based on the relationship or affiliation. For example, an analyst being paid by an entity (e.g., company) to cover its' security may be more inclined to issue a favorable prediction for the security. This type of information may benefit an investor or other user in determining whether a research report is truly objective.

Users may also wish to receive additional information about a particular research report prior to accessing the report, including, for example, the cost (if any) to access the research report, the number of pages of the research report, or the file size (bytes) of the research report for downloading. A user may also wish to preview an abstract or snapshot of the research report.

According to an embodiment of the invention, a user may obtain any of the foregoing information by selecting an “information” link, icon, or other access mechanism (not illustrated) displayed in close proximity to the research report icon (or object). Other display positions may of course be used. According to an alternative embodiment, a user may obtain additional information by selecting the actual research report icon (or object) itself. This information may be displayed along with prompts to either proceed to access (e.g., purchase) the research report, or to cancel and return to a previous view. Other implementations may exist

Several additional features and functions enabled by the system and method of the invention will now be disclosed within the context of an exemplary illustration of the Ticker Digest functionality. It should be understood that these and other features (e.g., the ability to display a list of analysts having current predictions for a selected earnings event for a given security, commingled with historical performance data) may be used separate and apart from the Ticker Digest.

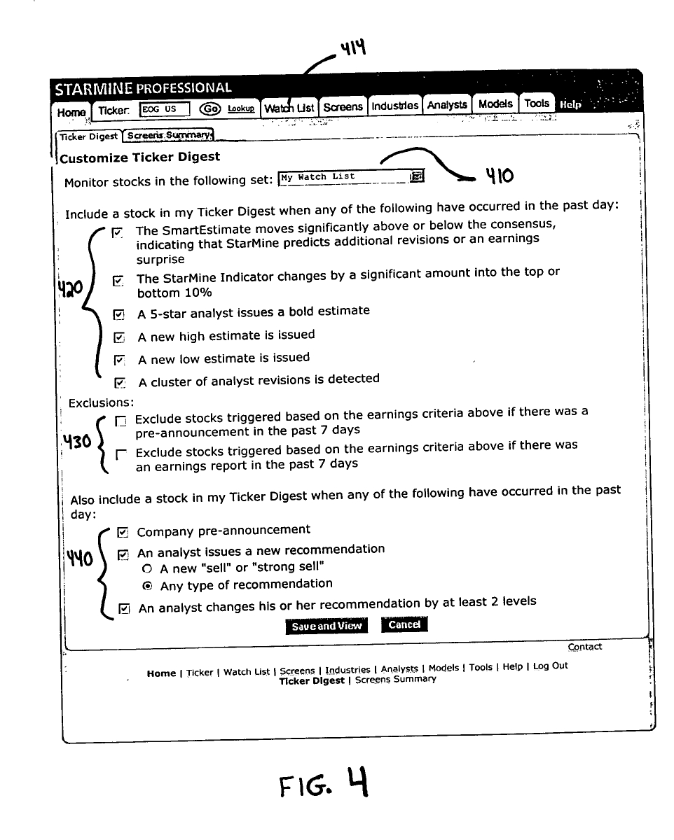

FIG. 4 is an example of a view that may be presented to a user wishing to access or subscribe to a Ticker Digest to customize monitoring criteria and other parameters for securities of interest. A user may first select which stocks to monitor via a drop-down menu 410. Drop-down menu 410 may set forth a number of stock sets to monitor including, for example, all stocks, Dow Industrials, FTSE 100, FTSE 350, Nikkei 225, Russel 1000, Russel 2000, Russel 3000, S&P 400, S&P 500, S&P 600, or other stock sets. In addition, a user may select to monitor one or more stocks or stock sets in a user-created “My Watch List.” According to one embodiment, a “My Watch List” may be created or edited by selecting “Watch List” tab 414. Selecting tab 414 may result in a subsequent view (not illustrated) being presented to a user in which the user may identify stocks (e.g., by stock name, ticker symbol, etc.) or groups of stocks to be included in the “My Watch List.”

Once a user has selected a set of stocks to be monitored, he or she may further customize monitoring criteria for the stock set. This criteria may comprise inclusion criteria, exclusion criteria, and miscellaneous criteria. For example, in data field 420, a user may indicate that a stock should be included in the Ticker Digest when one or more events have occurred during a specified time period (e.g., in the past day). Examples of such events may include, but are not limited to, detection of a new high estimate, low estimate, or cluster of revisions; detecting when a 5-star analyst has issued a bold estimate (described below); detecting when the SmartEstimate for the stock moves significantly above or below the consensus which may indicate expected additional revisions or an earnings surprise; or detecting when the Starmine Indicator changes by a significant amount into the top or bottom 10%. Both the SmartEstimate and Starmine Indicator are described in more detail in one or more of the U.S. patent applications incorporated herein by reference.

In data field 430, a user may also identify criteria which may be excluded from monitoring, according to an embodiment of the invention. For example, a user may wish to exclude stocks triggered based on the earnings criteria included in data field 420 if there was a pre-announcement or earnings report during a specified time period (e.g., within the past 7 days). Other exclusion criteria may be provided.

According to an embodiment of the invention, additional monitoring criteria may be specified by a user in data field 440. For example, a user may indicate that a stock should be included in the Ticker Digest when a company has made a pre-announcement, when an analyst issues a new recommendation, or when an analyst has changed his or her recommendation by a designated number of levels during a specified time period (e.g., in the past day). Other criteria may be provided.

Once a user has customized and personalized their Ticker Digest, the selected stock set may be monitored for the specified criteria. Customization and monitoring may be performed, either in part or whole, by Ticker digest module 148 (FIG. 1).

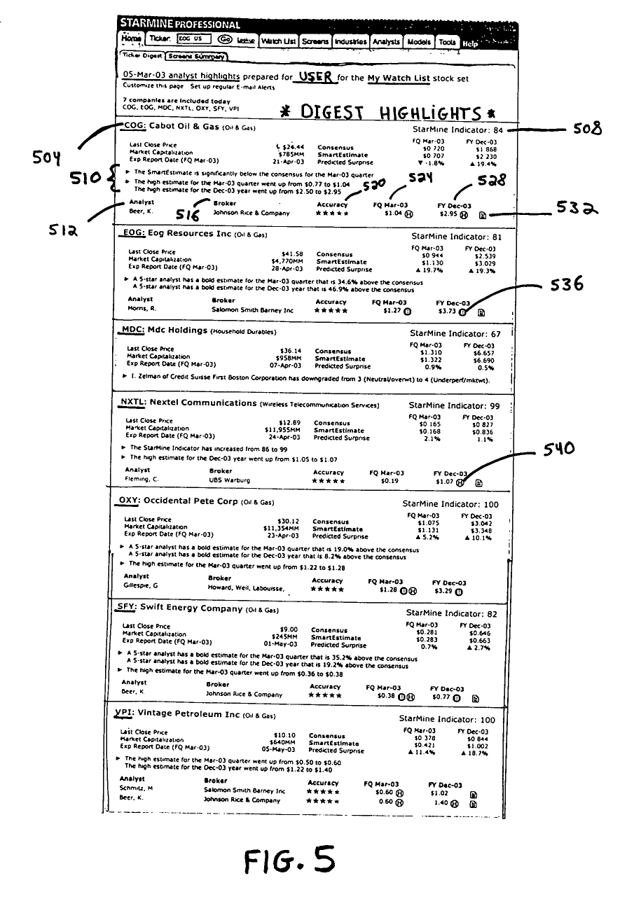

According to various embodiments, a user may obtain information on the stocks that have triggered one or more criteria in any number of ways. For example, according to one implementation, a user may access a “Digest Highlights” view (see FIG. 5) at his or her own leisure (e.g., whenever application 130 is accessed) to view highlights categorized by date, for example. According to another implementation, a user may specify that Digest Highlights be output in electronic format (e.g., via e-mail, text message, etc.) to one or more of terminal 112, remote terminal 110, or wireless terminal 114. Digest Highlights may be further transmitted to any other suitable output device such as, for instance, a facsimile. Output transmissions may occur at a user-specified, scheduled interval (e.g., hourly, daily, weekly, etc.), or whenever a triggering criteria has been satisfied. Other implementations may be possible. Although not illustrated, preferences for the delivery, scheduling, and format of output may be specified by users in data field 440 in FIG. 4.

FIG. 5 illustrates an example of a Digest Highlights view that a user may access, or receive via an output transmission as described above. In this example, for the date Mar. 5, 2003, seven securities from a stock set have been identified as meeting one or more of the inclusion, exclusion, or miscellaneous criteria defined by a user in FIG. 4. The securities may be identified and listed in alphabetical order by entity name or ticker symbol (e.g., COG, EOG, MDC, NXTL, OXY, SFY, VPI), or listed in any other meaningful order. For each stock identified, a multitude of information may be displayed. Referring to the data displayed for COG, for example, the Starmine Indicator 508 for the stock may be displayed. Values for the Last Close Price, Market Capitalization, Exp. Report Date, Consensus, SmartEstimate, and Predicted Surprise may also be displayed. In display section 510, a brief text synopsis of which particular criteria have been satisfied for the stock may also be provided.

One of the advantages of the Ticker Digest is the ability to identify relevant activity by proven analysts, on stocks of interest to users. This functionality may serve to greatly facilitate the research process, by enabling users to begin their research with what is perhaps the most relevant information. In column 512, for example, the name of the analyst or analysts that have triggered the one or more criteria for the given stock is displayed. The broker or other entity with which the analyst is affiliated (if any) may be displayed in column 516.

In column 520, a relative accuracy star rating for the analyst is displayed. In other embodiments, other measures of accuracy may be displayed, such as relative accuracy scores, or the analyst's ranking for the stock. In FIG. 5, all analysts for the seven stocks appearing in the Digest Highlights view have 5-star ratings, as this was one of the criteria selected by the user in data field 420 in FIG. 4. In addition to an accuracy rating, the analyst's earnings estimate for the stock for a first time period (e.g., FQ Mar-03) may be provided in column 524. The analyst's earnings estimate for the stock for a second time period (e.g., FY Dec-03) may also be displayed in column 528. In column 532, research report objects corresponding to each estimate are provided to enable users to access the research reports directly from this view.

According to an embodiment of the invention, additional indicators may be associated with particular information to further emphasize the potential value or importance of the information. For example, in FIG. 5, an encircled “H” 540 or other graphical representation may be displayed next to an earnings estimate if that earnings estimate represents a new high estimate.

In addition, an encircled “B” 536 or other graphical representation may be displayed next to a non-consensus prediction made by a “distinguished” or historically accurate analyst. The “B” may indicate that the analyst has made a “bold” prediction. Although such predictions may be referred to herein as “bold estimates,” it should be understood that “bold recommendations” may also be used where appropriate.

According to an embodiment of the invention, a bold estimate may be an estimate that deviates significantly from the consensus on a stock, stock sets, and/or other earnings events. As previously described, relative accuracy scores measure the accuracy of each analyst's forecasts as compared against fellow analysts. For an analyst to receive a high score, the analyst may make estimates that are both significantly different from and more accurate than other analysts' estimates. Top performing (or 5-star) analysts may have deviated from the consensus in the past and have been significantly more accurate than the other analysts. Accordingly, when a five star analyst makes a bold call, this often signals a major opportunity on the stock (or earnings event).

According to an embodiment of the invention, a user may wish to view additional analysts' predictions for a stock appearing in the Digest Highlights view. In particular, a user may wish to view (in a single display screen) a list of some or all of the analysts having current predictions for a selected earnings event for the given security, further commingled with historical performance data for each of the analysts. To access this commingled data for a security of interest, a user can select a link or other selection portion displayed with that particular security in the Digest Highlights view. For example, in FIG. 5, the COG stock ticker 504 may comprise a link or other navigation tool that, when selected, presents a user with a commingled view.

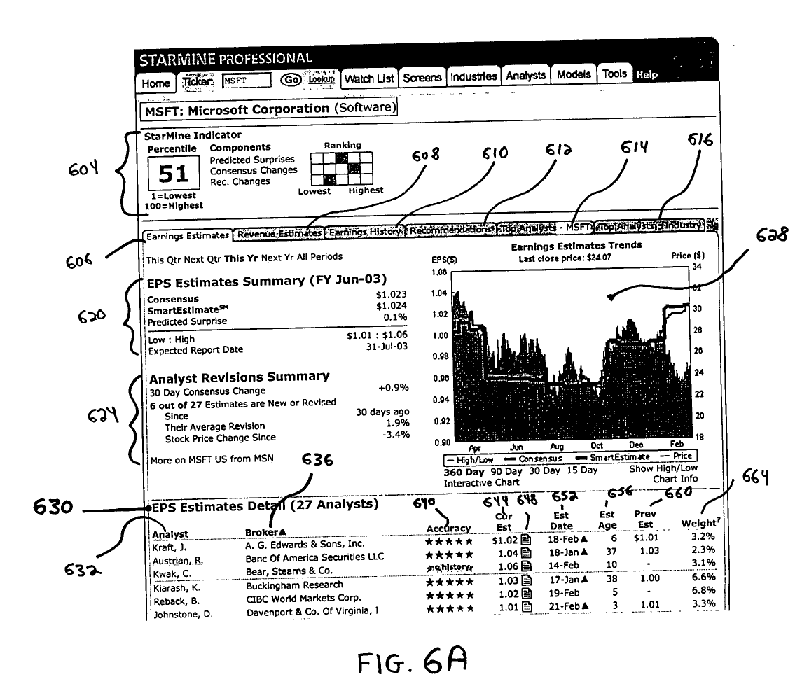

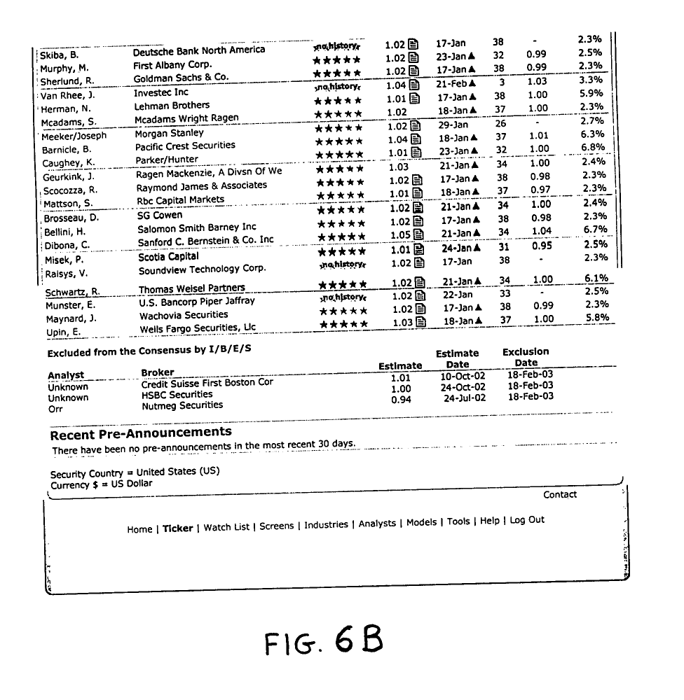

FIGS. 6A-6B illustrate an example of a commingled view that may be presented to a user, according to an embodiment of the invention. As shown, this view displays information pertaining to Microsoft Corporation. This view may be accessed by selecting a “MSFT” stock ticker link or other navigational tool in a Digest Highlights view if the stock happens to be included in a Digest Highlights view. This view may also be accessed by a user that is filtering research reports by security. Additional methods of access may be provided.

According to one embodiment, Starmine Indicator data may be displayed at section 604. Additionally, a group of user-selectable tabs (606, 608, 610, 612, 614, and 616) may enable users to access various groupings of information pertaining to Microsoft. Selecting tab 606, for example, may enable a user to view earnings estimates data for Microsoft. Selecting tab 608 may result in the display of revenue estimates data. Tab 610 may be selected to view earnings history data, while recommendations data may be obtained by selecting tab 612. A user may view a listing of top analysts (e.g., 5-star analysts only) for Microsoft by “clicking-on” tab 614, or for the software industry by selecting tab 616. Other information may be accessible.

According to the embodiment illustrated in FIG. 6A, various data pertaining to earnings estimates may be displayed when tab 606 is selected. For instance, an EPS Estimates Summary section 620 may display Consensus, SmartEstimate, Predicted Surprise, and low/high values for a give time period (e.g., FY Jun-03). Additionally, in section 624, data corresponding to analyst revisions may be presented. This data may include, among other things, the number of estimates that have been revised during a given time period, along with the average revisions (%) and the stock price change since the revisions. An earnings estimates trends graph 628 may also be displayed.

In section 630, a user may simultaneously view a list of all or some of the analysts having current estimates for Microsoft, research report objects corresponding to the current estimates, and an indication of each analyst's historical performance for Microsoft (if available). For example, column 632 may list each analyst by name. The broker or other entity with which the analyst is affiliated (if any) may be displayed in column 636. In column 640, a relative accuracy star rating for the analyst is displayed. In other embodiments, other measures of accuracy may be displayed, such as relative accuracy scores, or the analyst's ranking for the stock. The analyst's earnings estimate for the stock for a selected time period may be displayed in column 644, while column 648 may display accessible research report objects corresponding to each estimate provided, to enable users to access the research reports directly from this view. Other data including estimate date (column 652), estimate age (column 656), previous estimate (660), and weight (column 664) may be displayed.

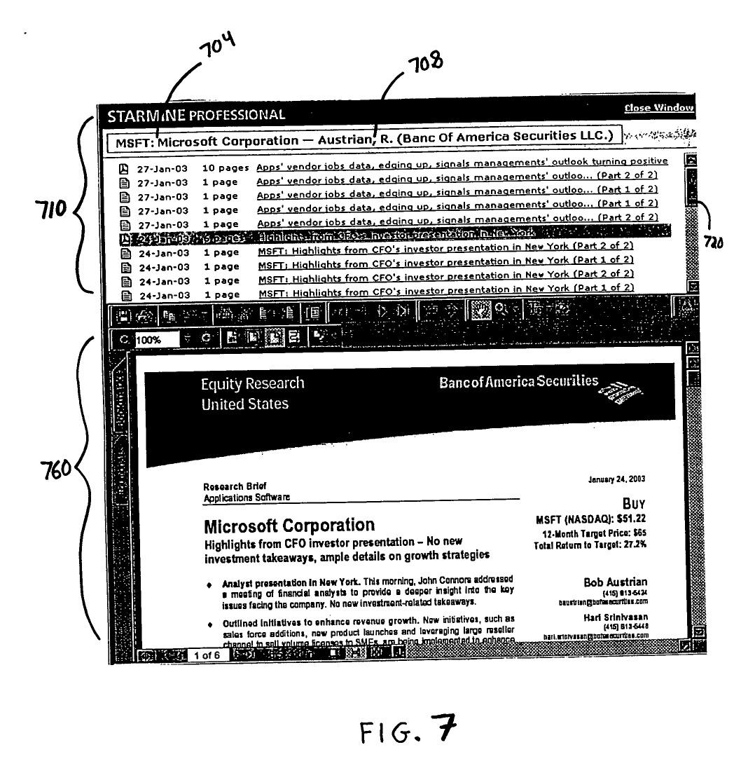

According to an embodiment of the invention, when a user selects research report objects from any of the views illustrated in FIGS. 2, 3, 5, or 6A-6B, he or she may be presented with a view similar to that illustrated in FIG. 7. A first display pane 710 may include a listing of all available research reports corresponding to the security (e.g., Microsoft) identified in section 704, for the analyst whose name is displayed at section 708. Other data including, for instance, the format of the research report (e.g., text file, Adobe Acrobat™ *.pdf file, etc.), the date of the report, the length of the report (in pages), and the tile of the report may be listed in display pane 710. In certain embodiments where a user must pay to access a listed research report, the price of the report may be listed. The file size (e.g., in bytes) of the research report may also be listed for those users interested in downloading one or more reports to any suitable storage media. Other data may listed. A user may also scroll through the list of available research reports using a scroll mechanism 720.

To preview a research report, a user may “click-on” or otherwise highlight or select the desired research report in display pane 710. This may launch a preview pane 760. For those embodiments where a user must pay to access research reports, preview pane 760 may comprise a “read-only” preview pane, thus preventing a user form printing, opening, downloading, or otherwise managing the previewed research report without paying.

In other embodiments, preview pane 760 may provide users with the full capability to access a complete research report for reading, printing, or downloading. In yet other embodiments, preview pane 760 may comprise an actual program (e.g., Adobe Acrobat™) that is launched when a user selects the desired research report in display pane 710. Other configurations or implementations may exist.

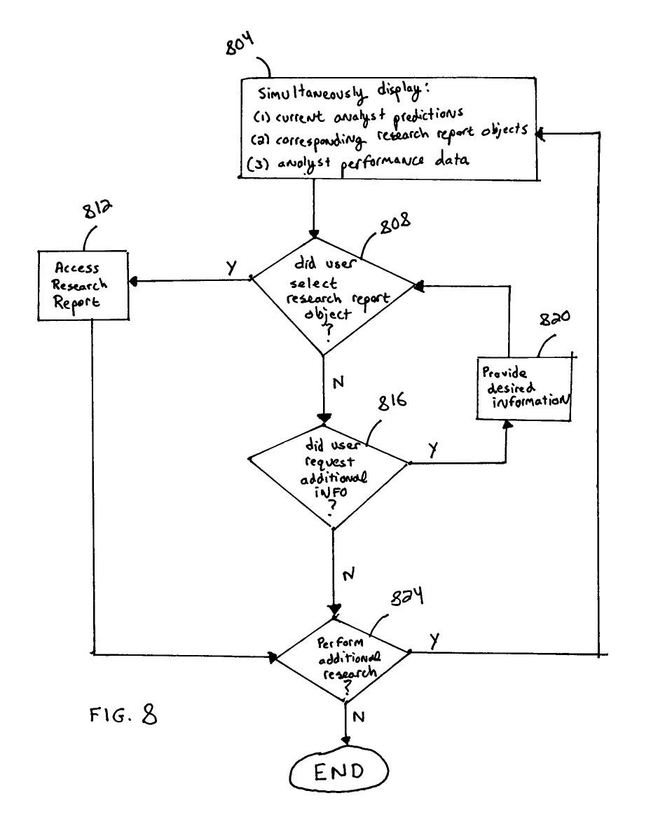

In addition to the foregoing description, FIG. 8 illustrates a flowchart of one method of processing, according to the invention, in one regard. The following operations may be accomplished using all or some of the of the system components described in detail above, and may incorporate all of the features and functionality of the invention as set forth in the foregoing description and accompanying drawing figures.

In an operation 810, investors (or other users) seeking to efficiently target and access only those security analyst research reports most likely to assist in an investment-related decision may access an application. The application may enables users to simultaneously view (e.g., via a graphical user interface) current analysts' predictions, research report objects associated with the predictions, and data, metrics, or other information corresponding to the historical performance of predictions made by the analysts. By simultaneously displaying historical performance data for analysts, along with their current predictions and research report objects associated with their current predictions, users are provided with objective criteria by which to guide their selection of research reports.

A determination may be made, in an operation 808, whether a user selected a research report object associated with an analyst's current prediction. If it is determined that a user did select a research report object, the selected research report may be accessed and displayed to a user in an operation 812.

By contrast, if a determination is made, in operation 808, that a user did not select a research report object corresponding to an analyst's current prediction, a determination may be made in an operation 816 as to whether a user is requesting additional information. A user may request additional information about, for example, an analyst, an entity with which an analyst is affiliated, the cost (if any) to access a particular research report, the number of pages of the research report, and the file size (bytes) of the research report for downloading. A user may also wish to preview an abstract or snapshot of the research report prior to accessing to the research report. Information pertaining to existing affiliations or relationships between an analyst and an entity may be of particular value, especially in those instances where a relationship may bias or unduly influence an analyst's prediction and/or the content of the corresponding research report. If it is determined, in operation 816, that additional information was requested, this information may be provided to the user in an operation 820. Processing may then resume in operation 808.

However, in operation 816, if it is determined that a user is not requesting additional information, an additional determination may be made, in an operation 824, as to whether the user desires to perform additional research. If a user does wish to perform additional research, processing may resume with operation 804. By contrast, if it is determined that a user does not wish to perform additional research, processing may end.

Other embodiments, uses and advantages of the invention will be apparent to those skilled in the art from consideration of the specification and practice of the invention disclosed herein. Accordingly, the specification should be considered exemplary only.

1. A computer-implemented system for helping users efficiently identify and access research reports for one or more securities, the system comprising:
means for accessing research reports for a plurality of contributors;
means for filtering the research reports based on at least a measure of the contributors' past performance; and
means for displaying, in a graphical user interface, a filtered listing of research report objects corresponding to the research reports that have been filtered.

2. The system of claim 1, wherein the research report objects comprise links that, when selected by a user, enable the user to access the corresponding research reports.

3. The system of claim 2, wherein accessing a research report comprises at least one of purchasing, viewing, downloading, or printing the research report.

4. The system of claim 1, wherein the measure of the contributors' past performance comprises at least one of a measure of estimate accuracy for each contributor on one or more securities, or a measure of profitability of stock ratings for each contributor on one or more securities.

5. A computer-implemented system for helping users efficiently identify and access research reports for one or more securities, the system comprising:
means for simultaneously displaying, in a graphical user interface, a listing of research report objects corresponding to research reports authored by one or more contributors, along with historical performance data for the one or more contributors.

6. The system of claim 5, wherein current predictions for the one or more contributors are also simultaneously displayed with the research report objects and historical performance data.

7. The system of claim 5, wherein the research report objects comprise links that, when selected by a user, enable the user to access the corresponding research reports.

8. The system of claim 7, wherein accessing a research report comprises at least one of purchasing, viewing, downloading, or printing the research report.

9. The system of claim 7, further comprising means for means for enabling a user to obtain additional information about a research report prior to accessing the research report.

10. The system of claim 5, wherein historical performance data comprises at least one of a measure of estimate accuracy for each contributor on one or more securities, or a measure of profitability of stock ratings for each contributor on one or more securities.

11. A computer-implemented system for helping users efficiently identify and access research reports for one or more securities, the system comprising means for simultaneously displaying, in a graphical user interface:
(i) a listing of research report objects corresponding to research reports authored by one or more contributors, wherein the research report objects comprise icons that, when selected by a user, enable the user to access the corresponding research reports;
(ii) historical performance data for the one or more contributors; and
(iii) means for enabling a user to obtain additional information about a research report prior to accessing the research report.

12. The system of claim 11, wherein the additional information comprises additional information about at least one of a contributor, entities with which the contributor is affiliated, or a research report.

13. A computer-implemented system for helping users efficiently identify and access research reports for one or more securities, the system comprising means for simultaneously displaying, in a graphical user interface:
(i) a list of some or all securities covered by a contributor;
(ii) the contributor's current prediction for one or more fiscal events for each security listed;
(iii) at least one measure of the contributor's historical performance for each security listed; and
(iv) research report objects corresponding to one or more research reports authored by the contributor for each security listed.

14. The system of claim 13, wherein the current prediction comprises an earnings estimate.

15. The system of claim 13, wherein the current prediction comprises a recommendation.

16. The system of claim 13, wherein the measure of the contributor's historical performance comprises at least one of a measure of estimate accuracy for the contributor for each security listed, or a measure of profitability of stock ratings for the contributor for each security listed.

17. The system of claim 13, wherein the research report objects comprise links that, when selected by a user, enable the user to access the corresponding research reports.

18. The system of claim 17, wherein accessing a research report comprises at least one of purchasing, viewing, downloading, or printing the research report.

19. A computer-implemented system for helping users efficiently identify and access research reports for one or more securities, the system comprising means for simultaneously displaying, in a graphical user interface:
(v) a list of contributors having current predictions for a given security, for a selected fiscal event;
(vi) current predictions for the given security from each contributor listed;
(vii) a measure of each contributor's historical performance for the given security; and
(viii) research report objects corresponding to one or more research reports authored by each contributor listed for the given security.

20. The system of claim 19, wherein the current predictions comprise earnings estimates.

21. The system of claim 19, wherein the current predictions comprise recommendations.

22. The system of claim 19, wherein the measure of each contributor's historical performance for the given security comprises at least one of a measure of estimate accuracy for each contributor for the given security, or a measure of profitability of stock ratings for each contributor for the given security.

23. The system of claim 19, wherein the research report objects comprise icons that, when selected by a user, enable the user to access the corresponding research reports.

24. The system of claim 19, wherein accessing a research report comprises at least one of purchasing, viewing, downloading, or printing the research report.
